(19) United States
(12) Patent Application Publication
(10) Pub. No.: US 2019/0145557 A1
(43) Pub. Date: May 16, 2019

(54) CONNECTING DEVICE, IN PARTICULAR IN THE FORM OF A HOSE COUPLING

(71) Applicant: EISELE PNEUMATICS GMBH & CO. KG, Waiblingen (DE)

(72) Inventor: Bernhard MUELLER, Leutenbach (DE)

(21) Appl. No.: 16/098,179

(22) PCT Filed: Mar. 29, 2017
(86) PCT No.: PCT/EP2017/000382

§ 371 Date: Nov. 1, 2018

(30) Foreign Application Priority Data
May 2, 2016 (DE) 10 2016 005 301.1

(51) Int. Cl. F16L 19/065; F16L 33/32

(52) U.S. Cl. CPC F16L 19/0653; F16L 19/061; F16L 33/32

(57) ABSTRACT

A connecting device, in particular in the form of a hose coupling, with two coupling parts (3, 5) which are connectable to each other and are releasable again from each other and of which the one (3) uses a securing device (51) to secure a connecting hose (1) which produces a fluid-conducting connection to a connecting channel (15) of the other coupling part (5) in the coupled state, and with a sealing system (37, 71) which has a sealing ring (37) which, arranged in the region of the free end (7) of a coupling part (3), surrounds the accommodated connecting hose in a sealing manner, is characterized in that the sealing ring (37) projects over the free end (7) of the one coupling part (3) outwards towards the environment by a pre-determinable axial excess length, with a sealing surface (39) for the connecting hose (1) being formed.

The invention relates to a connection device, in particular in the form of a hose coupling, having two coupling parts, which can be connected to each other and released again, one of which secures a connection hose by means of a fastening device, which in the coupled state establishes a fluid-conducting connection to a connection channel of the other coupling part, and having a sealing system comprising a sealing ring which, arranged in the region of the free end of a coupling part, encompasses the incorporated connection hose in a sealing manner.

Connection devices of this type are state of the art. By way of example, DE 10 2010 034 475 A1 shows a connection device of this type, which can be used in fluid-related devices for connecting pipe or hose lines, which are used to transport a multitude of flowable media. These may be gaseous media, such as compressed air, working gases or the like, or liquids of various kinds. In many cases, such connection devices are also used in the pharmaceutical industry or in the food industry, in areas in which particularly high standards of hygiene have to be observed. In such applications, it is therefore common to perform cleaning measures on the connection devices at short intervals where the connection devices are exposed to cleaning agents and/or steam jet operations. In the known connection devices, this results in impairments in particular due to the penetration of cleaning media, such as liquids and or steam.

In view of this, the invention addresses the problem of providing a connection device of the type mentioned, which permits the implementation of intensive cleaning operations without affecting the operational reliability.

According to the invention, this problem is solved by a connection device having the features of claim 1 in its entirety.

According to the characterizing part of claim 1, a significant feature of the invention is that the sealing ring protrudes beyond the free end of a coupling part by a predetermined axial projection to form a sealing surface for the connection tube outwards toward the environment. As a result, the sealing ring not only forms the seal between the outside of the connection hose and the receiving coupling part, but also forms a barrier at the critical transition point between the end of the coupling and the hose. As a result, the connection device is protected at the possible entry point against any foreign media intruding from the outside, such that correspondingly intensive cleaning operations can be safely conducted.

In particularly advantageous exemplary embodiments, the sealing ring has a further sealing surface for the sealing at the connection hose, which surface projects into the interior of the one coupling part at an offset from the one sealing surface. In that way, the further sealing surface is encompassed and radially supported by a coupling part.

With particular advantage, the arrangement can be made such that the further sealing surface viewed in the longitudinal section of the sealing ring follows a convex trajectory for an opening of the coupling part left uncovered by the connection tube, which trajectory converts into a flatter overall sealing surface, wherein the two outer curved or oblique sealing surface parts are moved to the rear by the incorporation of the connection tube. Owing to the contact of the connection tube, which deforms the curved overall sealing surface into a flatter shape, a pre-stress increasing the sealing force results, which pre-stress is intensified at an expansion of the hose diameter caused by the internal pressure due to the fluid in the connection hose.

With particular advantage, the sealing ring may have on its outer circumference a carrier web, which engages with a receiving groove of a coupling part, the free end of which extends over the carrier web with an end web and the outer peripheral side of which is in contact with the sealing ring. As a result, this outer peripheral side is secured in position by positive engagement with the receiving groove.

Advantageously, the arrangement may be such that an outer sealing part of the sealing ring adjoins the end web of the coupling part and at least partially rests against the latter, which outer sealing part supports a part of the further sealing surface at the inner periphery.

In advantageous exemplary embodiments, the connection hose for activating the sealing force effect of the sealing ring is displaceable up to a sealing contact surface on the other coupling part, wherein during the coupling process, in which the one coupling part can be connected, preferably screwed, to the other coupling part, the one coupling part carries a collet connected to the former, which closes, controlled by a control bevel in the other coupling part, upon increasing fastening process, the jaws of the collet on the connection hose at least up to a clamping contact with the latter in a releasable manner. The coupling process thereby not only effects the mechanical connection of the coupling parts, but also achieves the axial securing of the connection hose.

Advantageously, the arrangement can be made such that the other coupling part in the region of an outer visible side between convex outer wall parts has flat sections and such that in each case a further sealing ring of the sealing system adjoins both ends of this visible side. Of these further sealing rings, one can form a sealing connection between the first coupling part and the second coupling part in the coupled state, and the other of the further sealing rings can act in a sealing manner between the second coupling part and a coupling receptacle, which is used to continue the fluid-conducting connection. The flat sections form grip recesses, which facilitate the tightening of the threaded joint during the coupling process.

The visible side of the other coupling part can advantageously in each case form an undercut for these further sealing rings, with which the parts of each assignable further sealing ring engage. Thereby a seat is formed for these further sealing rings, which seat prevents an evasive radial movement of these sealing rings.

The arrangement can be made with particular advantage such that the one further sealing ring of the other coupling part is compressed by the first coupling part when the coupling parts are fastened to each other and that the other sealing ring of the other coupling part is compressed when it is mounted to the coupling support.

In particularly advantageous exemplary embodiments, the control bevel of the other coupling part can frontally form another seal of the sealing system by contact against a carrier web, which is formed on a coupling part for the collet. When connecting the coupling parts, not only is an end stop formed for the connection process, for instance by screwing, but an additional sealing connection is simultaneously formed on this stop.

A synthetic rubber material, in particular EPDM, may advantageously be provided as a material for the sealing rings of the sealing system. The entirety of the sealing rings of the sealing system including their fastening options results in a housing closed to the outside, such that no dirt can accumulate on the gap-free outer housing.

Below the invention is explained in detail with reference to an exemplary embodiment shown in the drawing.

In the drawings:

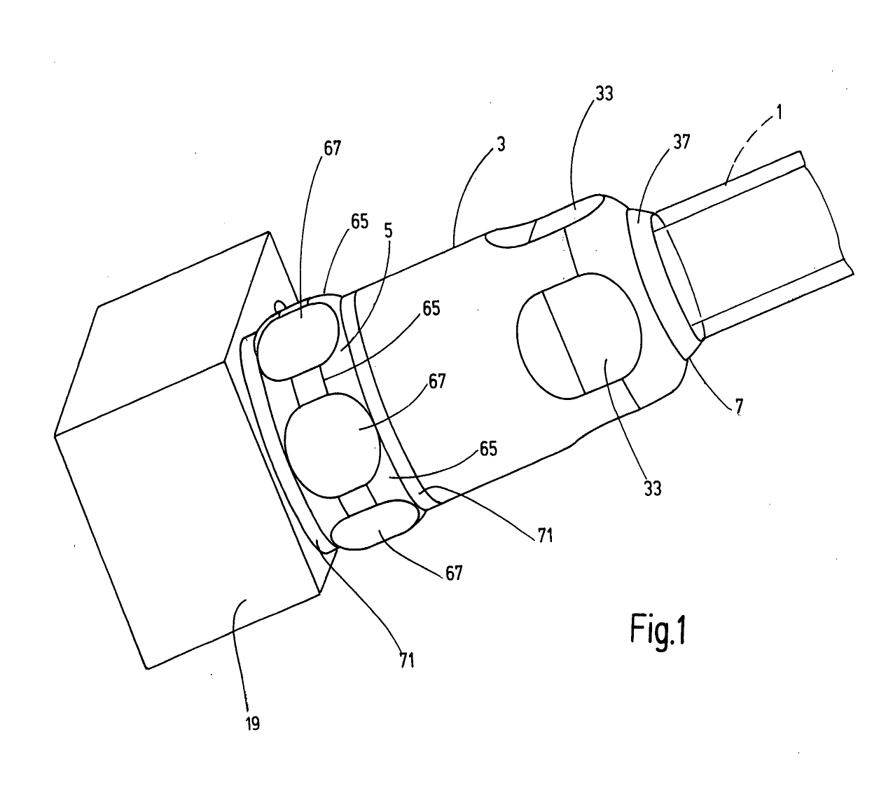

FIG. 1 shows a perspective oblique view of an exemplary embodiment of the connection device in the coupled state according to the invention, enlarged approximately by a factor of 2 in relation to a practical embodiment, wherein the connected connection hose is indicated only as an outline;

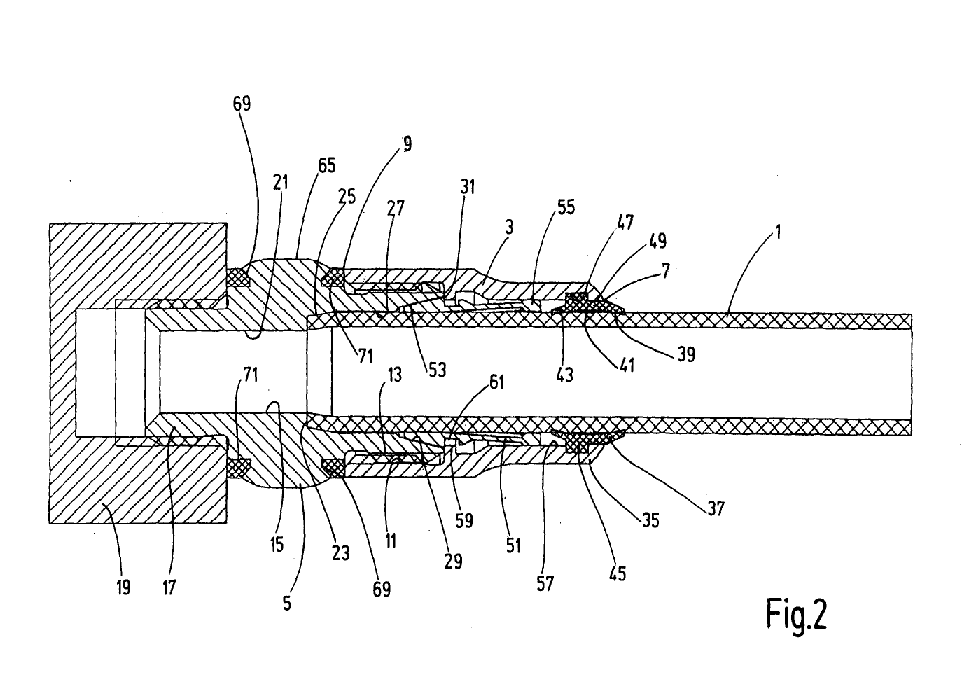

FIG. 2 shows a longitudinal section of the exemplary embodiment in the coupled state;

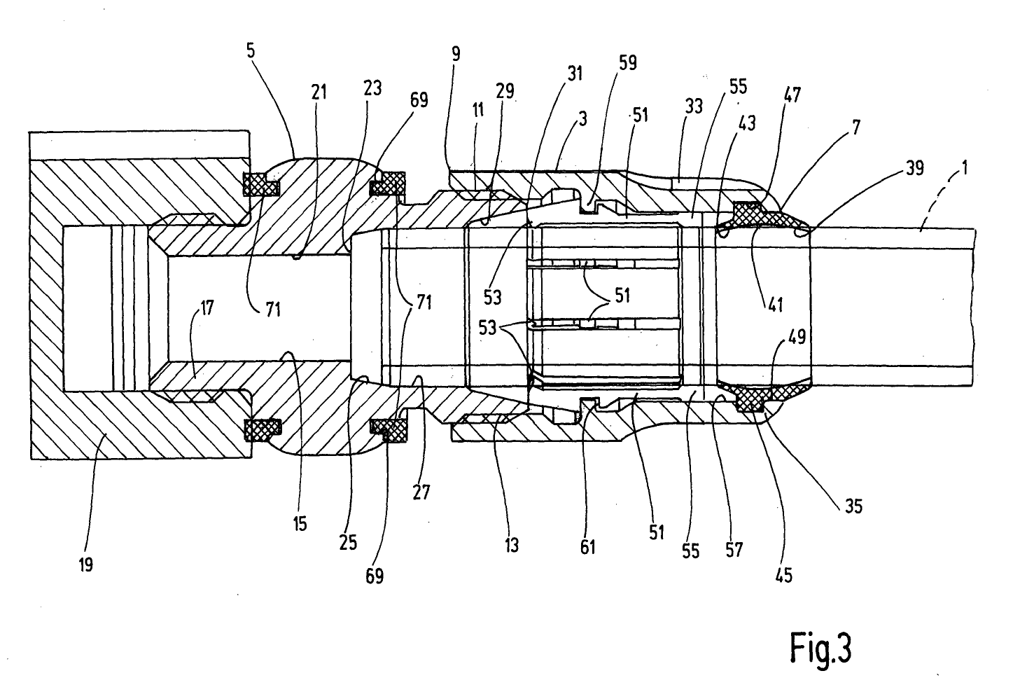

FIG. 3 shows a longitudinal section of the exemplary embodiment in the uncoupled state, wherein the connection hose is shown only as an outline; and

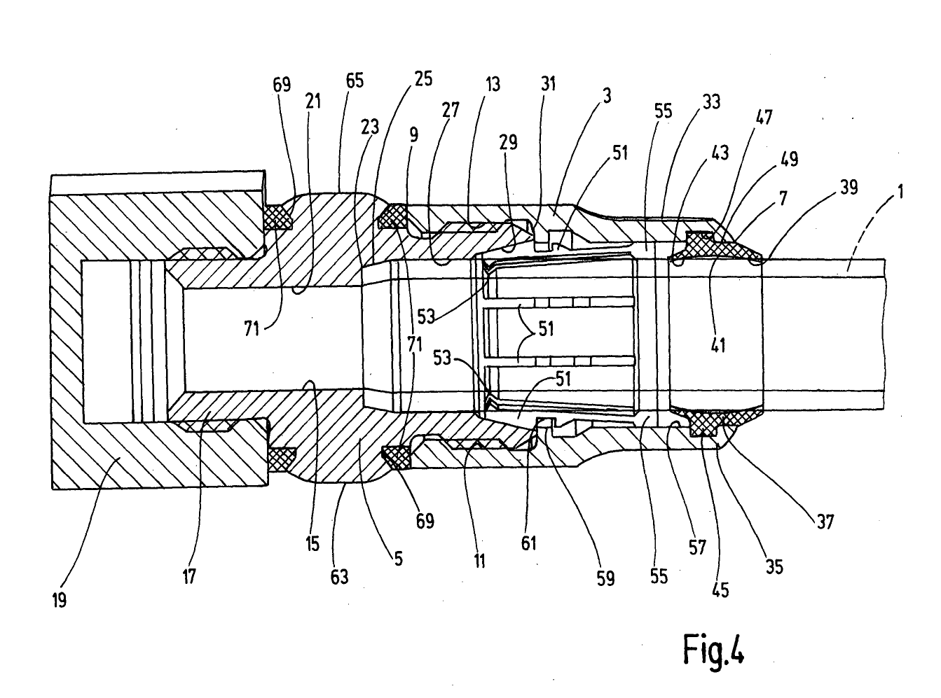

FIG. 4 shows a longitudinal section corresponding to FIG. 3, wherein the coupled state is shown.

With reference to the drawing, the invention is described using the example of a connection device, which is provided for the connection of a relatively pressure-resistant connection hose 1, allowing a passage of liquid, pasty or gaseous media, such as compressed air, at pressures of 20 bar or more, therethrough. The connection device has a first coupling part 3 and a second coupling part 5, as main housing parts, which can be screwed together to effect the coupled state. The first coupling part 3 has the shape of a sleeve which, starting from its open end 7, on the right in the figures, through which the connection hose 1 can be inserted, widens bell-like towards its other open end 9. A female thread 11 is provided in the inner wall portion which adjoins the end 9, which female thread is used to screw the first coupling part 3 to the second coupling part 5, which has a male thread 13 at its end region facing the first coupling part 3. To continue the fluid path coming from the inserted connection hose 1, the second coupling part 5 has a coaxial through-hole 15, and the end of the second coupling part 5 facing away from the first coupling part 3 forms a threaded connector 17, which is used to screw the second coupling part 5 to a coupling receptacle 19, which in turn forms the continuation of the fluid path (not shown).

The through-hole 15 is stepped and has, starting from the outlet at the threaded connector 17, a circular cylindrical drilled-hole section 21, which, as can be seen most clearly in FIGS. 3 and 4, transitions at a step 23 via an inner cone 25 into a second circular cylindrical bore section 27 having a slightly enlarged diameter. A further inner cone 29 adjoins this drilled-hole section 27, which inner cone forms a further widening of the bore 15 and terminates in a tip 31, which forms the outer edge of the second coupling part 5. As shown most clearly in FIG. 2, the outer circumferential surface of inserted connection hose 1 abuts the second cylindrical drilled hole section 27 and the inner cone 25 forming a constriction of the drilled hole, wherein the step 23 between the inner cone 25 and the first cylindrical drilled-hole section 21 forms a sealing contact surface and the end stop for the end 33 of the connection hose 1.

The outer wall surface of the bell-shaped first coupling part 3 has, in the vicinity of the end 7, which forms the opening for the insertion of the connection hose 1, a plurality of flat sections 33 distributed around the sleeve circumference, which, as FIG. 1 most clearly shows, form a kind of grip recess, which facilitates the tightening of the threaded joint between the first and second coupling part 3 and 5. In the area between the end 7 forming the insertion opening and the flat sections 33, the first coupling part 3 forms an end web 35, on which the seat for a main sealing ring 37 of the sealing system of the device is formed. The sealing ring 37 is a molded gasket made of a synthetic rubber material, in this example made of EPDM.

The inner diameter of the sealing tube 37 surrounding the inserted connection hose 1 in this exemplary embodiment is approximately 1.6 times its axial length, and the sealing ring 37 is arranged on the inner side of the end web 35 such that it axially protrudes approximately one third of its axial length beyond the end 7 of the first coupling part 3, wherein it forms a first sealing surface 39 for the connection hose 1. Axially inwardly offset from the first sealing surface 39, the sealing ring 37 forms a further sealing surface 41, which has a convexly curved shape if the connection hose 1 is not inserted, as indicated in FIGS. 3 and 4. For an inserted connection hose 1, however, this shape is essentially flattened such that a converted or deformed overall sealing surface 41 is formed from the first sealing surface 39 forming an outer sealing surface part and from an inner sealing surface part 43. Pressure present in the connection hose 1 in operation results an increase in the sealing force when the overall sealing surface 41 is flattened, due to the widening of the hose diameter. On the outer periphery, the sealing ring 37 has a carrier web 45 in the form of a radially protruding annular rib, which sits in a receiving groove 47, which is formed in the end web 35, such that a positive axial lock for the sealing ring 37 is formed. An outer sealing part 49 of the sealing ring 37 rests against the end section of the end web 35 located between the receiving groove 47 and the end 7.

To axially secure the inserted connection hose 1, a collet coupled to the first coupling part 3 is provided, which clamps the connection hose 1 in the activated state. The collet has a plurality of strip-shaped clamping jaws 51 having terminal clamping prongs 53 surrounding the tube 1. The ends of the clamping jaws 51 opposite of the tines 53 start from a guide ring 55, which is displaceable along the inner wall 57 of the coupling part 3. For actuating the collet, the coupling part 3 has a radially inwardly projecting driving ring 59, which engages with a driving groove 61 of the clamping jaws 51 and axially entrains the clamping jaws 51 during the coupling process, wherein the first coupling part 3 and second coupling part 5 are moved against each other. In doing so, the clamping jaws 51 run along the inner cone 29 of the second coupling part 5, wherein the inner cone 29 acts as a control bevel, which closes the clamping jaws 51 in the clamping direction. As shown most clearly in FIG. 4, the tip 31 at the end of the inner cone 29 of the second coupling part 5 forming the control bevel is in contact with the driving ring 59 of the first coupling part 3, thus forming an additional inner seal, after coupling, due to the tightening of the threaded joint between the first and second coupling part 3 and 5.

The second coupling part 5 has flat sections 67 located at a peripheral section 63 between convex, spherical peripheral parts 65, which flat sections, like the flat sections 33 on the first coupling part 3, form a kind of recessed grip to facilitate the tightening of the threaded joint. On both sides of the region of the flat sections 67, an undercut 69 is in each case formed on the outer circumference of the second coupling part 5 as a seat for a further sealing ring 71. As shown in FIGS. 2 and 4, in the coupled state with tightened threaded joint, the one further sealing ring 71 is compressed by the end 9 of the first coupling part 3 and the other further sealing ring 71 is compressed by fastening the second coupling part 5 to the coupling receptacle 19, such that the connection points between the first and second coupling part 3 and 5 and between the latter and the coupling receptacle 19 are reliably covered against the environment due to the strong sealing force generated by the threaded joint. Instead of EPDM material, other suitable elastomers can be used for the sealing parts or sealing rings (37, 71).

1. A connection device, in particular in the form of a hose coupling, having two coupling parts (3, 5), which can be connected to each other and released again, one (3) of which secures a connection hose (1) by means of a fastening device (51), which in the coupled state establishes a fluid-conducting connection to a connection channel (15) of the other coupling part (5), and having a sealing system (37, 71) comprising a sealing ring (37), which, arranged in the region of the free end (7) of a coupling part (3), encompasses the incorporated connection hose in a sealing manner, characterized in that the sealing ring (37) projects beyond the free end (7) of the one coupling part (3) to the outside by a predetermined axial projection thereby forming a sealing surface (39) for the connection hose (1).

2. The connection device according to claim 1, characterized in that the sealing ring (37) has a further sealing surface (41) for sealing at the connection hose (1), which projects from the one sealing surface (39) with an offset into the interior of the one coupling part (3).

3. The connection device according to claim 1, characterized in that the further sealing surface (41) viewed in the longitudinal section of the sealing ring (37) follows a convex trajectory for an opening of the coupling part (3) left uncovered by the connection hose (1), which trajectory converts into a flatter overall sealing surface (41), wherein the two outer curved or oblique sealing surface parts (39, 43) are moved to the rear by the incorporation of the connection hose (1).

4. The connection device according to claim 1, characterized in that the sealing ring (37) has a carrier web (45) on its outer circumference which engages with a receiving groove (47) of a coupling part (3), the free end of which extends over the carrier web (45) with an end web (35) and the outer peripheral side of which is in contact with the sealing ring (37).

5. The connection device according to claim 1, characterized in that an outer sealing part (49) of the sealing ring (3) adjoins the end web (35) of the coupling part (3) and at least partially rests against the latter, which outer sealing part supports a part of the further sealing surface (41) at the inner periphery.

6. The connection device according to claim 1, characterized in that the connection hose (1) for activating the sealing force effect of the sealing ring (37) is displaceable up to a sealing contact surface (23) on the other coupling part (5), wherein during the coupling process, in which the one coupling part (3) can be connected, preferably screwed, to the other coupling part (5), the one coupling part carries a collet (51) connected to the former, which, controlled by a control bevel in the other coupling part, upon increasing fastening process, closes the jaws (53) of the collet (51) on the connection hose (1) at least up to a clamping contact with the latter in a releasable manner.

7. The connection device according to claim 1, characterized in that the other coupling part (5) has flat sections (67) in the region of an outer visible side between convex outer wall parts (65) and that in each case a further sealing ring (71) of the sealing system adjoins at both ends of these flat sections (67).

8. The coupling device according to claim 1, characterized in that in each case the visible side of the other coupling part (5) forms an undercut (69) for the further sealing rings (71), with which the parts of each assignable further sealing ring (71) engage.

9. The connection device according to claim 1, characterized in that in each case the one further sealing ring (71) of the other coupling part (5) is compressed by the first coupling part (3) when the coupling parts are fastened to each other and that the other sealing ring (71) of the other coupling part (5) is compressed when it is fastened to the coupling holder (19).

10. The connection device according to claim 1, characterized in that the control bevel (29) of the other coupling part (5) frontally forms a further seal (31) of the sealing system by contact with a carrier web (59), which is formed on a coupling part (3) for the collet (51).

11. The connection device according to claim 1, characterized in that the one (37) and the two further sealing rings (71) of the sealing system are preferably made of EPDM.

12. The connection device according to claim 1, characterized in that the coupling parts (3, 5) in the mutually coupled state in conjunction with the sealing rings (37, 71) and the connected connection hose (1) form a surface design largely free of joints and edges.
